(19) United States
(12) Patent Application Publication
(10) Pub. No.: US 2025/0184794 A1
(43) Pub. Date: Jun. 5, 2025

(54) DELAY REPORTING FOR COHERENT JOINT TRANSMISSION

(71) Applicant: Samsung Electronics Co., Ltd., Suwon-si (KR)

(72) Inventors: Gilwon Lee, McKinney, TX (US); Md. Saifur Rahman, Plano, TX (US); Eko Onggosanusi, Coppell, TX (US)

(21) Appl. No.: 18/949,624

(22) Filed: Nov. 15, 2024

Related U.S. Application Data
(60) Provisional application No. 63/605,304, filed on Dec. 1, 2023.
(60) Provisional application No. 63/575,249, filed on Apr. 5, 2024.
(60) Provisional application No. 63/634,051, filed on Apr. 15, 2024.

(51) Int. Cl. H04W 24/10; H04L 5/00

(52) U.S. Cl. CPC H04W 24/10; H04L 5/0051

(57) ABSTRACT

Apparatuses and methods for delay and frequency reporting for coherent joint transmission. A method performed by a user equipment (UE) includes receiving information about a report, the information indicating N_{TRP} antenna groups, where N_{TRP}>1, determining, based on the information, a reference antenna group n_{ref}, and determining, based on the information and the reference antenna group n_{ref}, for each antenna group n≠n_{ref}, a first delay value Dₙ and a second delay value dₙ. The method further includes transmitting the report including a first indicator indicating the reference antenna group n_{ref}, a second indicator indicating, for each antenna group n≠n_{ref}, an interval to which the first delay value Dₙ belongs, and a third indicator indicating, for each antenna group n≠n_{ref}, whether the second delay value dₙ is inside or outside a pre-defined range via a 1-bit indicator.

### CROSS-REFERENCE TO RELATED AND CLAIM OF PRIORITY

The present application claims priority under 35 U.S.C. § 119(e) to U.S. Provisional Patent Application No. 63/605,304 filed on Dec. 1, 2023; U.S. Provisional Patent Application No. 63/575,249 filed on Apr. 5, 2024; and U.S. Provisional Patent Application No. 63/634,051 filed on Apr. 15, 2024, which are hereby incorporated by reference in their entirety.

### TECHNICAL FIELD

The present disclosure relates generally to wireless communication systems and, more specifically, the present disclosure is related to apparatuses and methods for delay and frequency reporting for coherent joint transmission.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to delay and frequency reporting for coherent joint transmission.

In one embodiment, a user equipment (UE) is provided. The UE includes a transceiver configured to receive information about a report. The information indicates N_{TRP} antenna groups, where N_{TRP}>1. The UE further includes a processor operably coupled to the transceiver. The processor is configured determine, based on the information, a reference antenna group n_{ref}; and determine, based on the information and the reference antenna group n_{ref}, for each antenna group n≠n_{ref}, a first delay value Dₙ and a second delay value dₙ. The transceiver is further configured to transmit the report including a first indicator indicating the reference antenna group n_{ref}, a second indicator indicating, for each antenna group n≠n_{ref}, an interval to which the first delay value Dₙ belongs, and a third indicator indicating, for each antenna group n≠n_{ref}, whether the second delay value dₙ is inside or outside a pre-defined range via a 1-bit indicator.

In another embodiment, a base station (BS) is provided. The BS includes a processor and a transceiver operably coupled to the processor. The transceiver is configured to transmit information about a report. The information indicates N_{TRP} antenna groups including a reference antenna group n_{ref}, where N_{TRP}>1. For each antenna group n≠n_{ref}, a first delay value Dₙ and a second delay value dₙ, is based on the information and the reference antenna group n_{ref}. The transceiver is further configured to receive the report including a first indicator indicating the reference antenna group n_{ref}, a second indicator indicating, for each antenna group n≠n_{ref}, an interval to which the first delay value Dₙ belongs, and a third indicator indicating, for each antenna group n≠n_{ref}, whether the second delay value dₙ is inside or outside a pre-defined range via a 1-bit indicator.

In yet another embodiment, a method performed by a user equipment (UE). The method includes receiving information about a report, the information indicating N_{TRP} antenna groups, where N_{TRP}>1, determining, based on the information, a reference antenna group n_{ref}, and determining, based on the information and the reference antenna group n_{ref}, for each antenna group n≠nef, a first delay value Dₙ and a second delay value dₙ. The method further includes transmitting the report including a first indicator indicating the reference antenna group n_{ref}, a second indicator indicating, for each antenna group n≠n_{ref}, an interval to which the first delay value Dₙ belongs, and a third indicator indicating, for each antenna group n≠n_{ref}, whether the second delay value dₙ is inside or outside a pre-defined range via a 1-bit indicator.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of an antenna port layout according to embodiments of the present disclosure;

FIG. 11 illustrates examples of a UE moving on a trajectory located in co-located and distributed antenna groups (AGs) according to embodiments of the present disclosure; and

FIG. 12 illustrates an example method performed by a UE in a wireless communication system according to embodiments of the present disclosure.

### DETAILED DESCRIPTION

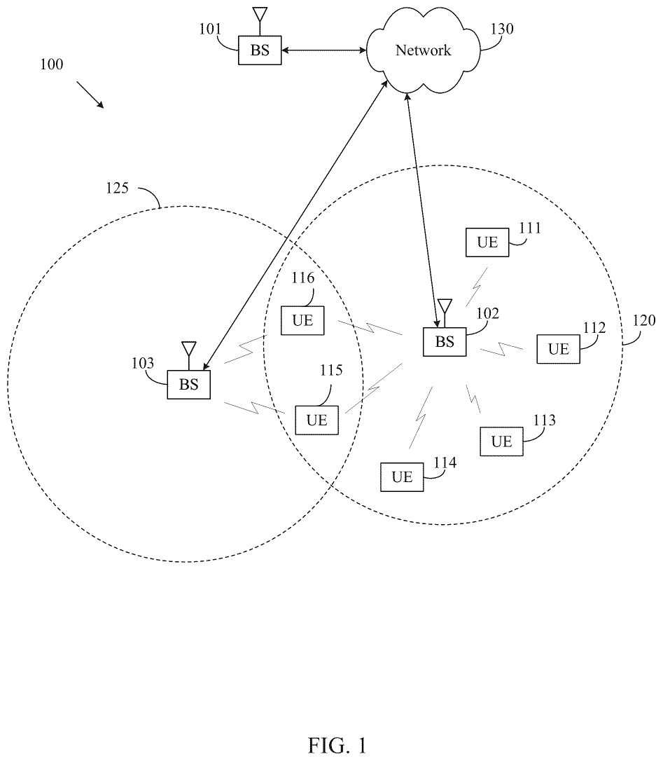

FIGS. 1-12 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF1] 3GPP TS 36.211 v17.4.0, “E-UTRA, Physical channels and modulation;” [REF2] 3GPP TS 36.212 v18.0.0, “E-UTRA, Multiplexing and Channel coding;” [REF3] 3GPP TS 36.213 v18.0.0, “E-UTRA, Physical Layer Procedures;” [REF4]3GPP TS 36.321 v17.6.0, “E-UTRA, Medium Access Control (MAC) protocol specification;” [REF5]3GPP TS 36.331 v17.6.0, “E-UTRA, Radio Resource Control (RRC) Protocol Specification;” [REF6]3GPP TR 22.891 v1.2.0; [REF7] 3GPP TS 38.212 v18.0.0, “E-UTRA, NR, Multiplexing and Channel coding;” [REF8] 3GPP TS 38.214 v18.0.0, “E-UTRA, NR, Physical layer procedures for data;” and [REF9] 3GPP TS 38.211 v18.0.0, “E-UTRA, NR, Physical channels and modulation;”

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing delay and frequency reporting for coherent joint transmission. In certain embodiments, one or more of the BSs 101-103 include circuitry, programing, or a combination thereof to support delay and frequency reporting for coherent joint transmission.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

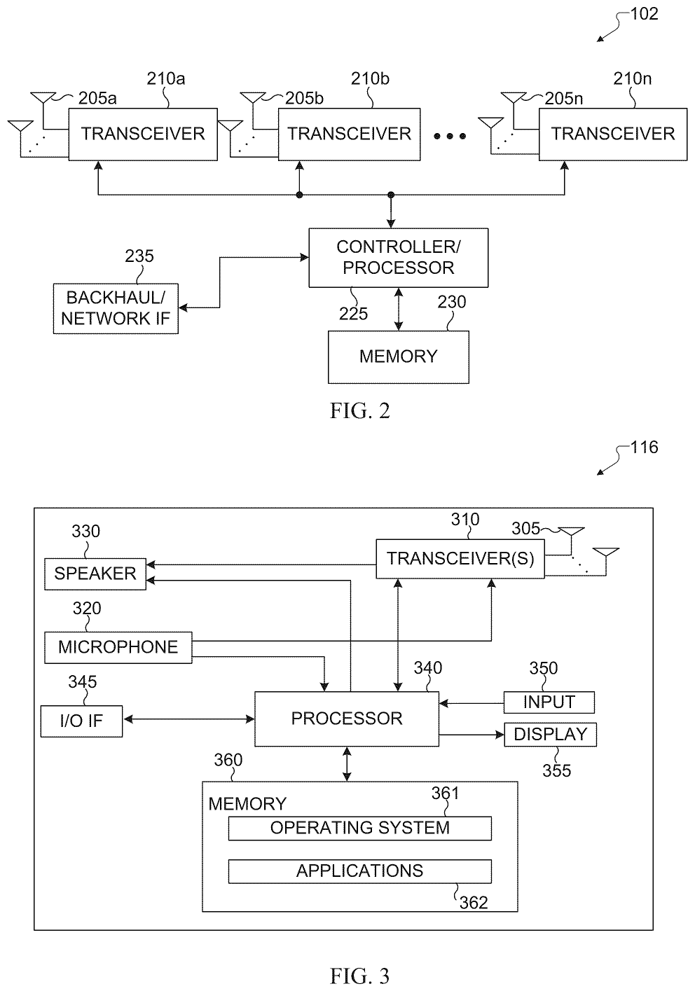

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for delay and frequency reporting for coherent joint transmission. Any of a wide variety of other functions could be supported in the gNB 102 by the controller/processor 225.

The controller/processor 225 is also capable of executing programs and other processes resident in the memory 230, such as processes to support delay and frequency reporting for coherent joint transmission. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for delay and frequency reporting for coherent joint transmission as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

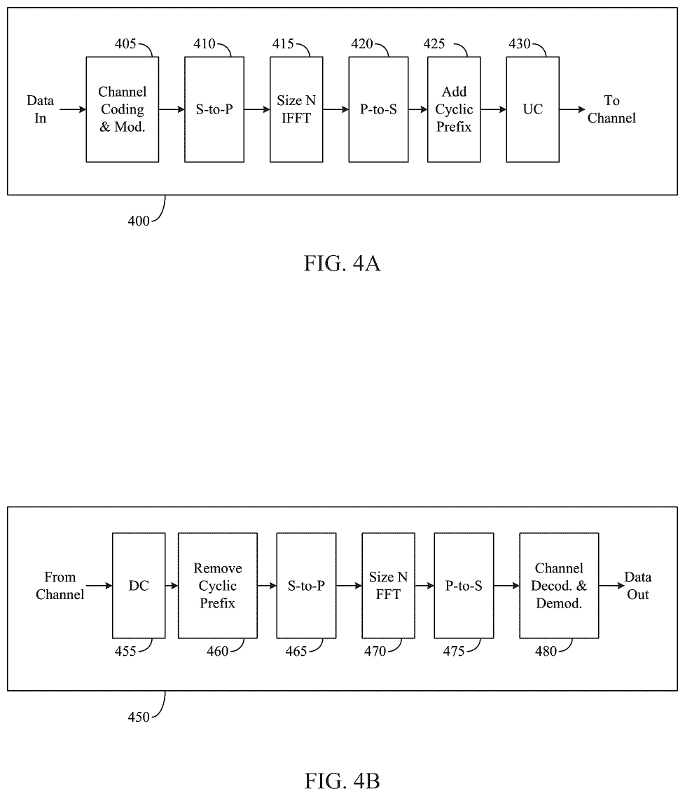

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for delay and frequency reporting for coherent joint transmission as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

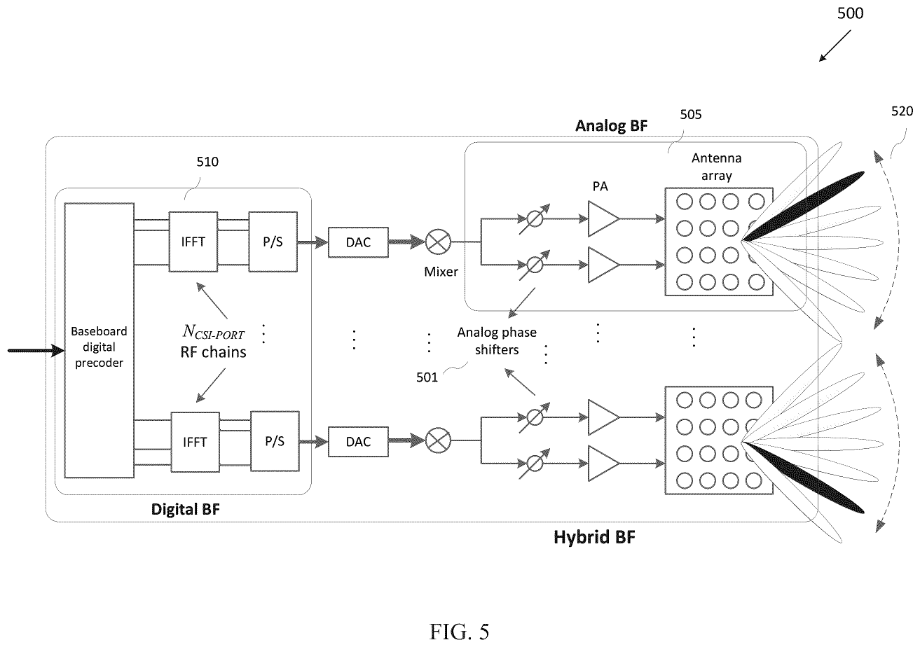

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). Although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency subbands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB (eNB) or gNodeB (gNB), which is generally a fixed station, may also be referred to as an access point or other equivalent terminology. For LTE systems, a NodeB is often referred as an eNodeB. For NR systems, a NodeB is often referred as an gNodeB.

In a communication system, such as NR or LTE, DL signals can include data signals conveying information content, control signals conveying DL Control Information (DCI), and Reference Signals (RS) that are also known as pilot signals. An eNodeB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS for time/frequency tracking (aka common reference signal (CRS) in LTE or TRS in NR), for CSI reporting. DMRS can be transmitted only in the bandwidth (BW) of a respective PDSCH and a UE can use the DMRS to demodulate data or control information in a PDSCH or a PDCCH, respectively. A transmission time interval for DL channels is referred to as a subframe or slot and can have, for example, duration of 1 millisecond or a value depending on the subcarrier-spacing (SCS).

DL signals also include transmission of a logical channel that carries system control information. A broadcast control channel (BCCH) is mapped to either a transport channel referred to as a Broadcast CHannel (BCH) when it conveys a Master Information Block (MIB) or to a DL Shared CHannel (DL-SCH) when it conveys a System Information Block (SIB)—see also REF3 and REF 5. Most system information is included in different SIBs that are transmitted using DL-SCH. A presence of system information on a DL-SCH in a subframe (or slot) can be indicated by a transmission of a corresponding PDCCH conveying a codeword with a cyclic redundancy check (CRC) scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes of frequency resource units referred to as Resource Blocks (RBs). Each RB includes N_{sc}^{RB} sub-carriers, or Resource Elements (REs), such as 12 REs. A unit of one RB over one subframe (or slot) is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNB/gNB can use a DMRS to demodulate data signals or UCI signals. A UE transmits SRS to provide an eNB/gNB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data transport block (TB) in a PDSCH or absence of a PDCCH detection (DTX), Scheduling Request (SR) indicating whether a UE has data in its buffer, and Channel State Information (CSI) enabling an eNB/gNB to perform link adaptation for PDSCH transmissions to a UE. HARQ-ACK information is also transmitted by a UE in response to a detection of a PDCCH indicating a release of semi-persistently scheduled PDSCH (see also REF 3).

An UL subframe (or slot) includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. A last few subframe (or slot) symbols can be used to multiplex SRS transmissions from one or more UEs.

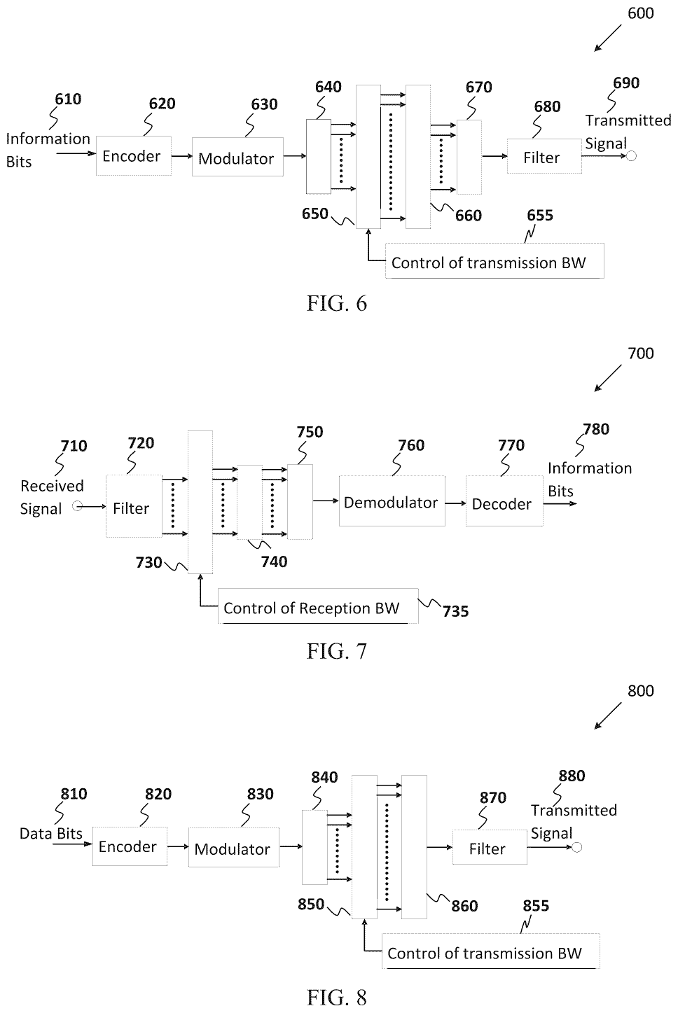

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

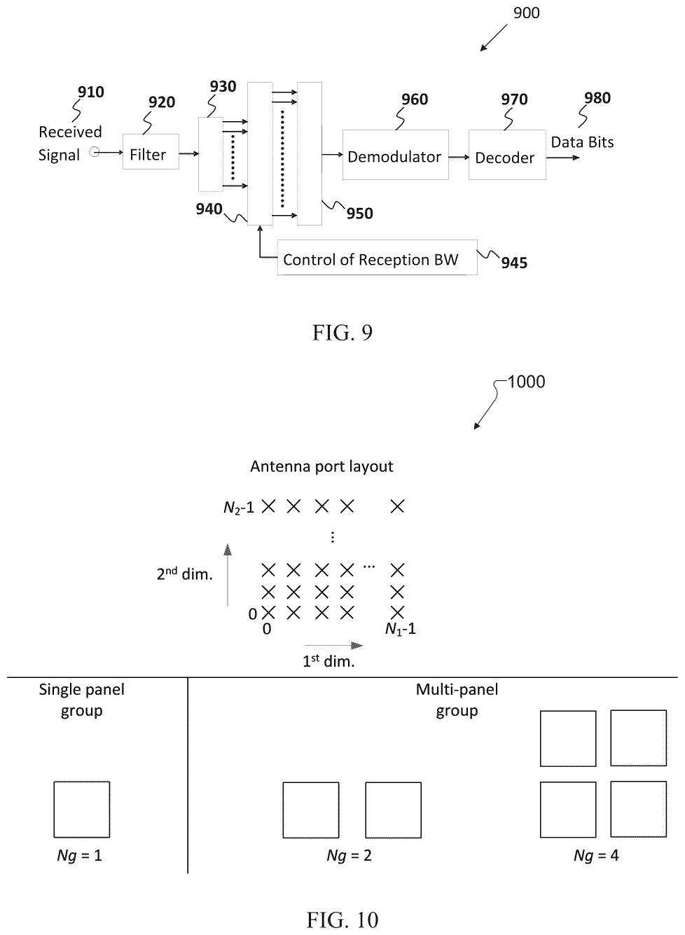

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies a FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown herein.

TABLE 0

| Frequency range | Corresponding |
|---|---|
| designation | frequency range |
| FR1 | 450 MHz-600 MHz |
| FR2 | 24250 MHz-52600 MHz |

For MIMO in FR1, up to 32 CSI-RS antenna ports in one CSI-RS resource is supported, and in FR2, up to 8 CSI-RS antenna ports in one CSI-RS resource is supported. A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital.

In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across antenna ports is feasible.

In next generation cellular standards (e.g. 6G), in addition to FR1 and FR2, new carrier frequency bands can be evaluated, e.g., FR4 (>52.6 GHz), terahertz (>100 GHz) and upper mid-band (10-15 GHz). The number of CSI-RS ports that can be supported for these new bands is likely to be different from FR1 and FR2. In particular, for 10-15 GHz band, the max number of CSI-RS antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (may be non-co-located, hence geographically separated) TRPs within a cellular region can be the main scenario of interest, due to which the number of CSI-RS antenna ports for MIMO can be even larger (e.g. up to 256).

Likewise, for a cellular system operating in low carrier frequency in general, a sub-1 GHz frequency range (e.g. less than 1 GHz) as an example, supporting large number of CSI-RS antenna ports (e.g. 32) or many antenna elements at a single location or remote radio head (RRH) or TRP is challenging due to a larger antenna form factor size needed taking into account carrier frequency wavelength than a system operating at a higher frequency such as 2 GHz or 4 GHz. At such low frequencies, the maximum number of CSI-RS antenna ports that can be co-located at a site (or RRH or TRP) can be limited, for example to 8. This limits the spectral efficiency of such systems. In particular, the multi user MIMO (MU-MIMO) spatial multiplexing gains offered due to large number of CSI-RS antenna ports (such as 32) can't be achieved due to the antenna form factor limitation. One plausible way to operate a system with large number of CSI-RS antenna ports at low carrier frequency is to distribute the physical antenna ports to different panels/RRHs/TRPs, which can be non-collocated. The multiple sites or panels/RRHs/TRPs can still be connected to a single (common) base unit forming a single antenna system, hence the signal transmitted/received via multiple distributed RRHs/TRPs can still be processed at a centralized location.

As described above, for low (FR1), high (FR2 and beyond), or mid (6-15 GHz) band, the NW topology/architecture is likely to be more and more distributed in future due to reasons explained above (e.g. use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In a wireless communication system, MIMO is often identified as an essential feature in order to achieve high system throughput requirements. One of the key components of a MIMO transmission scheme is the accurate CSI acquisition at the eNB (or gNB) (or TRP). For MU-MIMO, in particular, the availability of accurate CSI is necessary in order to guarantee high MU performance. For time division duplexing (TDD) systems, the CSI can be acquired using the SRS transmission relying on the channel reciprocity. For frequency division duplexing (FDD) systems, on the other hand, it can be acquired using the CSI-RS transmission from eNB (or gNB), and CSI acquisition and feedback from UE.

In 5G or NR systems [REF7, REF8], both low- (aka Type I) and high-resolution (aka Type II) CSI reporting mechanisms are supported. In addition, to reduce Type II CSI reporting, a frequency domain (FD) compression based Type II CSI is also supported, which is based on (a) spatial domain (SD) basis W₁, (b) FD basis W_{f}, and (c) coefficients \tilde{W}₂ that linearly combine SD and FD bases. For a (full TDD or partial FDD) reciprocity, CSI-RS ports can be beamformed (using SRS measurements, assuming UL-DL channel reciprocity in angular/delay), and the SD basis corresponds to a port selection basis.

In Rel.18, the FD-compression-based Type II CSI is further enhanced for the use case of CJT across up to 4 TRPs, under the idealistic assumptions such as perfectly time and frequency synchronized mTRPs, phase-coherent antenna ports and ideal backhaul links. In practice, however, these assumptions are not valid, and calibration/synchronization across TRPs is necessary in order to make CJT feasible.

Massive MIMO base stations or TRPs use an on-board coupling network and calibration circuits, referred to as the on-board calibration for brevity, to measure the gain and phase differences among transceivers in the same radio frequency (RF) unit in order to maintain the reciprocity between DL and UL channels, in the TDD system in particular. For the on-board calibration, one RF chain corresponding to one antenna port serves as a reference to other RF chains for other antenna ports. Embodiments of the present disclosure recognizes that in the case of the mTRP system, such reference transceiver's signal needs to be shared between distributed RRHs/panels/modules/TRPs, which are physically far apart or non-co-located. Using RF cables to distribute the reference is not preferable as it limits the deployment scenarios. In addition, the use of different local oscillators (LOs) between distributed antenna modules imposes even more challenges in achieving calibration as the phase of LOs could drift. Periodic calibration is needed to compensate for the phase drift as well.

Issue 1: In one example, the timing offset can be expressed as Tₜ=e^{j2πf(t+Δt)}, where Δt is due to timing difference between (distributed, non-co-located) TRPs or/and different propagation delays from different TRPs, which amounts to increased frequency-selectivity of the composite channel. The min freq. granularity (supported in NR) is 2 RBs (for precoding matrix indicator (PMI)) and 4 RBs (CQI), which correspond to a max delay spread 2.8 and 1.4 micro second for SCS=15 and 30 kHz, respectively. This delay spread decreases further with increasing freq. granularity (due to timing offset). For large delay spread, the required freq. granularity for CJT (across TRPs) will be smaller than 2 RBs.

TABLE 9.6.1.3-1
OTA frequency error minimum requirement

| BS class | Accuracy |
|---|---|
| Wide Area BS | ±0.05 ppm |
| Medium Range BS | ±0.1 ppm |
| Local Area BS | ±0.1 ppm |

Issue 2: In one example, the frequency offset can be expressed as T_{f}=e^{j2π(f+Δf)}^{^{t}}, where Δf is due to non-ideal (and may be different) local oscillators or crystal types at different TRPs, which results in frequency differences between TRPs. As shown above, the min freq. error=0.05 ppm, according to TS 38.104. The phase change due to freq. error can be significant, especially at higher carrier frequencies.

In general, the combined (time-frequency) T-F offset can be expressed as T_{t,f}=e^{j2π(f+Δf)(t+Δt)}. For CJT feasibility, (Δt,Δf) needs to be calibrated frequently.

Issue 3: non-ideal backhaul links between TRPs, especially when the backhaul links are not fiber-optic cables.

Issue 4: phase-coherency across antenna ports, both intra-TRP (within each TRP) and inter-TRP (across TRPs).

In various non-limiting embodiments of this disclosure, the mechanism are procedures are provided for Issue 1 and 2, which are more severe than Issue 3 and 4.

In one example, a TRP or RRH can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

This disclosure provides over-the-air (OTA) signaling mechanism for calibration among multiple TRPs or RRHs. The mechanism includes 1) DL RS (e.g. CSI-RS) transmission from mTRPs and measurement (by the UE) and 2) Reporting related to the calibration information (e.g. amp/phase of calibration coefficients). Aspects of the disclosure are as follows:
Two delay value reporting per TRP, and
Different bits for alphabet sets associated with the two delay values.

Although the focus of this disclosure is on 3GPP 5G NR communication systems, various embodiments may apply in general to UEs operating with other RATs and/or standards, such as different releases/generations of 3GPP standards (including beyond 5G, 6G, and so on), IEEE standards (such as 802.16 WiMAX and 802.11 Wi-Fi), and so on.

A description of example embodiments are provided on the following pages.

The text and figures are provided solely as examples to aid the reader in understanding the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the present disclosure are readily apparent from the following detailed description, simply by illustrating a number of particular embodiments and implementations, including the best mode contemplated for carrying out the present disclosure. Embodiments of the present disclosure also capable of other and different embodiments, and its several details can be modified in various obvious respects, all without departing from the spirit and scope of the present disclosure. Accordingly, the drawings and description are to be regarded as illustrative in nature, and not as restrictive. Embodiments of the present disclosure are illustrated by way of example, and not by way of limitation, in the figures of the accompanying drawings.

In the following, for brevity, both FDD and TDD are regarded as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure of disclosure covers several components which can be used in conjunction or in combination with one another, or can operate as standalone schemes.

The following components and embodiments are applicable for UL transmission with cyclic prefix OFDM (CP-OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI or calibration coefficient reporting setting.

“CSI or calibration coefficient reporting band” is defined as a set/collection of subbands, either contiguous or non-contiguous, wherein CSI or calibration coefficient reporting is performed. For example, CSI or calibration coefficient reporting band can include the subbands within the DL system bandwidth. This can also be termed “full-band”. Alternatively, CSI or calibration coefficient reporting band can include only a collection of subbands within the DL system bandwidth. This can also be termed “partial band”.

The term “CSI or calibration coefficient reporting band” is used only as an example for representing a function. Other terms such as “CSI or calibration coefficient reporting subband set” or “CSI or calibration coefficient reporting bandwidth” can also be used.

In terms of UE configuration, a UE (e.g., the UE 116) can be configured with at least one CSI or calibration coefficient reporting band. This configuration can be semi-static (via higher-layer signaling or RRC) or dynamic (via MAC CE or L1 DL control signaling). When configured with multiple (N) CSI or calibration coefficient reporting bands (e.g. via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 10 illustrates a diagram of an antenna port layout 1000 according to embodiments of the present disclosure. For example, antenna port layout 1000 of an antenna port layout can be implemented by the BS 102 of FIG. 2. This example is for illustration only and can be used without departing from the scope of the present disclosure.

With reference to FIG. 10, N₁ and N₂ are the number of antenna ports with the same polarization in the first and second dimensions, respectively. For 2D antenna port layouts, N₁>1, N₂>1, and for 1D antenna port layouts N₁>1 and N₂=1 (or N₁=1 and N₂>1). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 10 where “X” represents two antenna polarizations. In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g. X=3000, then antenna ports are 3000, 3001, 3002, . . . ). Dual-polarized antenna payouts are expected in this disclosure. The embodiments (and examples) in this disclosure however are general and are applicable to single-polarized antenna layouts as well.

Let N_{g} be a number of antenna groups (AGs). With reference to FIG. 10, when there are multiple antenna groups (N_{g}>1), each group (g∈{1, . . . , N_{g}}) including dual-polarized antenna ports with N_{1,g} and N_{2,g} ports in two dimensions is expected. Note that the antenna port layouts may be the same (N_{1,g}=N₁ and N_{2,g}=N₂) in different antenna groups, or they can be different across antenna groups. For group g, the number of antenna ports is P_{CSIRS,g}=N_{1,g}N_{2,g} or 2N_{1,g}N_{2,g}(for co-polarized or dual-polarized respectively).

In one example, an antenna group corresponds to an antenna panel. In one example, an antenna group corresponds to a TRP. In one example, an antenna group corresponds to an RRH. In one example, an antenna group corresponds to CSI-RS antenna ports of a non-zero power (NZP) CSI-RS resource. In one example, an antenna group corresponds to a subset of CSI-RS antenna ports of a NZP CSI-RS resource (comprising multiple antenna groups). In one example, an antenna group corresponds to CSI-RS antenna ports of multiple NZP CSI-RS resources (e.g. comprising a CSI-RS resource set).

In one example, an antenna group corresponds to a reconfigurable intelligent surface (RIS) in which the antenna group can be (re-)configured more dynamically (e.g. via MAC CE or/and DCI). For example, the number of antenna ports associated with the antenna group can be changed dynamically.

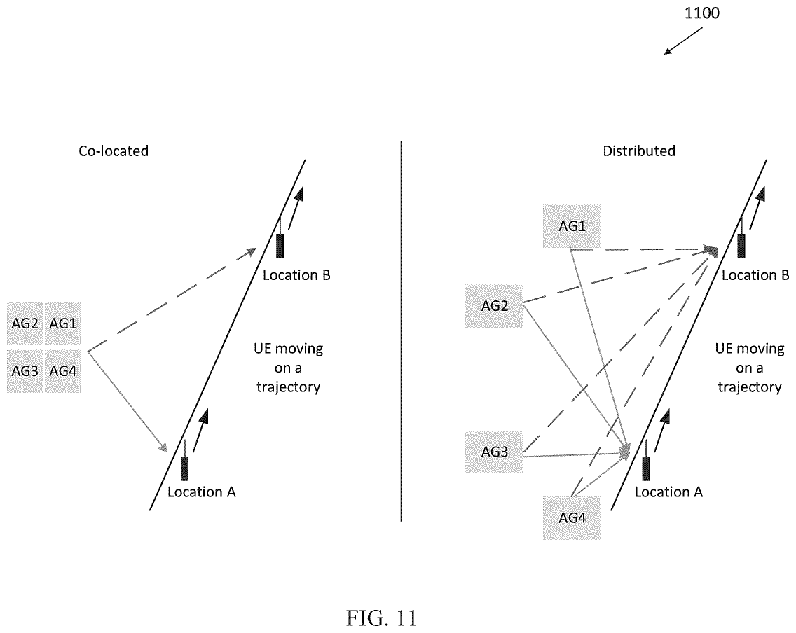

FIG. 11 illustrates examples of a UE moving on a trajectory 1100 located in co-located and distributed AGs according to embodiments of the present disclosure. For example, trajectory 1100 located in co-located and distributed AGs can be implemented by any of the UEs 111-116 of FIG. 1. This example is for illustration only and can be used without departing from the scope of the present disclosure.

In one example scenario, multiple AGs can be co-located or distributed, and can serve static (non-mobile) or moving UEs. With reference to FIG. 11, an illustration of AGs serving a moving UE is shown. While the UE moves from a location A to another location B, the UE measures the channel, e.g. via NZP CSI-RS resources, (may also measure the interference, e.g. via CSI interference measurement (CSI-IM) resources or CSI-RS resources for interference measurement), uses the measurement to determine/report CSI or calibration-related information taking into account joint transmission from multiple AGs.

In one example, the antenna architecture of the MIMO system is structured. For example, the antenna structure at each AG is dual-polarized (single or multi-panel as shown in FIG. 10. The antenna structure at each AG can be the same. Or the antenna structure at an AG can be different from another AG. Likewise, the number of ports at each AG can be the same. Or the number of ports at one AG can be different from another AG.

In another example, the antenna architecture of the MIMO system is unstructured. For example, the antenna structure at one AG can be different from another AG.

A structured antenna architecture is expected in the rest of the disclosure. For simplicity, each AG is equivalent to a panel (cf. FIG. 10), although, an AG can have multiple panels in practice. The disclosure however is not restrictive to a single panel assumption at each AG, and can easily be extended (covers) the case when an AG has multiple antenna panels.

In one embodiment, an AG constitutes (or corresponds to or is equivalent to) at least one of the following:
In one example, an AG corresponds to a TRP.
In one example, an AG corresponds to a CSI-RS resource. A UE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein.
In one example, an AG corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g. K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one example, an AG corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an AG. The information about the subsets of ports or grouping of ports can be provided together with the CSI-RS resource setting/configuration, or with the CSI reporting setting/configuration, or with the CSI-RS resource configuration.
In one example, an AG corresponds to one or more examples described herein depending on a configuration. For example, this configuration can be explicit via a parameter (e.g. an RRC parameter). Or, it can be implicit.
   In one example, when implicit, it could be based on the value of K. For example, when K>1 CSI-RS resources, an AG corresponds to one or more examples described herein, and when K=1 CSI-RS resource, an AG corresponds to one or more examples described herein.
   In another example, the configuration could be based on the configured codebook. For example, an AG corresponds to a CSI-RS resource or resource group when the codebook corresponds to a decoupled codebook (modular or separate codebook for each AG), and an AG corresponds to a subset (or a group) of CSI-RS ports when codebook corresponds to a coupled (joint or coherent) codebook (one joint codebook across AGs).

In one example, when AG maps (or corresponds to) a CSI-RS resource or resource group, and a UE can select a subset of AGs (resources or resource groups) and report the CSI or calibration-related information for the selected AGs (resources or resource groups), the selected AGs can be reported via an indicator (e.g. via UCI part 1 of a two-part UCI). For example, the indicator can be a CSI-RS resource indicator (CRI) or a PMI (component) or a new indicator (e.g. a bitmap).

In one example, when AG maps (or corresponds to) a CSI-RS port group, and a UE can select a subset of AGs (port groups) and report the CSI or calibration-related information for the selected AGs (port groups), the selected AGs can be reported via an indicator (e.g. via UCI part 1 of a two-part UCI). For example, the indicator can be a CRI or a PMI (component) or a new indicator (e.g. a bitmap).

In one example, CSI-RS herein in this disclosure comprises at least one or a combination of the following: CSI-RS for tracking (TRS), CSI-RS for CSI, CSI-RS for beam management (BM), CSI-RS for mobility or NZP CSI-RS resource for IMR (interference measurement) or a new type/usage of CSI-RS, namely, CSI-RS for calibration.

In one embodiment, a UE is configured with a calibration mechanism, wherein the UE is configured to perform one or more UL RS transmission(s), or/and to perform one or more DL RS reception(s)/measurement(s), and/or to report calibration-related information (e.g., for calibration coefficient for each TRP).

This configuration can be performed via higher-layer (e.g., RRC) signaling.
In one example, this configuration corresponds to a CSI resource setting configured via a higher layer IE CSI-ResourceConfig.
In one example, this configuration corresponds to a CSI resource set configured via a higher layer IE NZP-CSIRSResourceSet.
In one example, this configuration corresponds to a NZP CSI resource configured via a higher layer IE NZP-CSIRSResource.
In one example, this configuration corresponds to a CSI report setting configured via a higher layer IE CSI-ReportConfig.

In one example, the DL RS(s) can be one of or multiple of CSI-RS for CSI reporting, CSI-RS for tracking (TRS), CSI-RS for beam reporting, DL DMRS, or synchronization signal/physical broadcast channel (SSB/PBCH) or a new type/usage of CSI-RS, namely, CSI-RS for calibration. In one example, DL RS can be a dedicated or new DL RS (for calibration purpose).

In one example, the UL RS(s) can be one of or multiple of SRS with usage=CB, SRS with usage=non-CB, SRS with usage=beamManagement, SRS with usage=AntennaSwitching, or UL DMRS. In one example, UL RS can be a dedicated or new UL RS (for calibration purpose).

In one example, the DL RS(s) can be aperiodic (AP) only.

In one example, the DL RS(s) can be AP or semi-persistent (SP).

In one example, the DL RS(s) can be AP or periodic (P).

In one example, the DL RS(s) can be SP or P.

In one example, the DL RS(s) can be AP or SP or P.

In one example, the UL RS(s) can be aperiodic (AP) only.

In one example, the UL RS(s) can be AP or semi-persistent (SP).

In one example, the UL RS(s) can be AP or periodic (P).

In one example, the UL RS(s) can be SP or P.

In one example, the UL RS(s) can be AP or SP or P.

In one example, the reporting can only be AP. In this case, the reporting can be triggered via a DCI (e.g. a CSI request field in UL-DCI).

In one example, the reporting can either be AP or SP. For AP, the reporting can be triggered via a DCI (e.g. a CSI request field in UL-DCI), and for SP, it can be triggered via MAC CE or DCI.

In one example, the reporting can only be UE-initiated (or UE-triggered). In this case, the reporting can be triggered via UL MAC CE (e.g. MAC CE for power headroom report (PHR) reporting) or via a pre-notification message sent by the UE, where this message can be sent via SR (scheduling request) or via UCI (a pre-configured PUCCH or a PUSCH).

The term ‘precoder’ in this disclosure can be replaced with a spatial information (or transmission configuration indication (TCI) state, or spatialRelationInfo) or source RS or spatial filter, beamformer, beamforming vectors/matrices, precoding vector/matrices, or any other functionally equivalent quantity, that can be used for DL/UL RS reception/transmission.

In one embodiment, a UE (e.g., the UE 116) is configured with a measurement and a report (e.g. CSI or calibration report) including calibration-related information (CLI) to enable/facilitate calibration/synchronization across Nₜᵣₚ≥1 TRPs or AGs or CSI-RS resources. In one example, the measurement can be configured via higher layer IE CSI-ResourceConfig indicating S≥1 sets of NZP CSI-RS resources. In one example, the measurement can be configured via higher layer IE NZP-CSIRS-ResourceSet indicating a set of NZP CSI-RS resources. In one example, the measurement can be configured via higher layer IE MeasObj. In one example, the report can be configured via higher layer CSI-ReportConfig with reportType set to a new value, e.g. ‘calibration’ or ‘cjt-calibration’.

Let hᵣ be the measurement associated with r-th TRP (or CSI-RS resource or DL RS), where r=1, . . . , N and

$$H = [ \begin{matrix}{h}_{1} ( t - δ {t}_{1} , f - δ {f}_{1} ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ]$$

be the composite/aggregated channel at a T-F unit (t, f) and {(δtᵣ,δfᵣ)} be the offsets associated with TRPs, where N≤Nₜᵣₚ is configured by NW (e.g., MAC-CE, DCI, RRC), or reported by UE (e.g., via a bit-map indicator or a combinatorial indicator included in the CSI report) or N=N_{TRP}.

As described in this disclosure, one of the N TRPs can be a reference, whose offset can be fixed, e.g. to zero. Without loss generality, the reference TRP (resource) corresponds to (the 1^{st} TRP) r*=1 for which (δt₁,δf₁)=(0,0), i.e.,

$$H = [ \begin{matrix}{h}_{1} ( t , f ) \\ {h}_{2} ( t - δ {t}_{2} , f - δ {f}_{2} ) \\ ⋮ \\ {h}_{N} ( t - δ {t}_{N} , f - δ {f}_{N} )\end{matrix} ] .$$

In one example, values of (δtᵣ,δfᵣ), based on the measurement, can be evaluated/used to determine the report.

In one example, a low-pass or a window-based approach can be used for the report. In one example, the window corresponds to value of (δtᵣ,δfᵣ) that are around the reference. For instance, δtᵣ≤Wₜ and/or δfᵣ≤W_{f}, where (Wₜ,W_{f}) corresponds to the window length or max value of (δtᵣ,δfᵣ) that can be evaluated/used for the report, (Wₜ,W_{f}) can be fixed, or configured, or reported by the UE.

In one example, the unit of cross link interference (CLI) reporting is at least one of the following examples:
In one example, for time offset, the unit can be based on the CP length, or the symbol duration, or the slot duration. For example, 2^{N}^{_{T}} values within a window/interval, [0, x], x=CP length, min measurement interval. In one example, x=4.69×10⁻⁶ sec or 4.69 μsec. In one example, x=2^{z}×4.69×10⁻⁶ sec or 4.69 μsec where z∈{0, 1, 2, 3, 4}.
In one example, for time offset, the unit can be based on a fractional factor (between 0 and 1) of a time division (TD) unit. For example, 2^{N}^{_{T}} values within a window/interval, [0, x], x=TD unit length.
In one example, For frequency error (in ppm), the unit can be based on the window/interval, [0, x] or [−x,x], x=freq. error value specified in 38.104 (from RAN4). For example, 2^{N}^{_{F}} values within a window/interval, [0, x] or [−x,x], x=FD unit length. In one example, x=0.05 ppm (parts per million).
In one example, for time offset, the unit can be based on the normalized CP length, or the symbol duration, or the slot duration. For example, 2^{N}^{_{T}} values within a window/interval, [0, 1], 1 corresponds to CP length, min measurement interval. In one example, the CP length x=4.69×10⁻⁶ sec or 4.69 μsec. In one example, the CP length x=2^{z}×4.69×10⁻⁶ sec or 4.69 μsec where z∈{0, 1, 2, 3, 4}.
In one example, for time offset, the unit can be based on a normalized fractional factor (between 0 and 1) of a TD unit. For example, 2^{N}^{_{T}} values within a window/interval, [0, 1], 1 corresponds to TD unit length.
In one example, for frequency error (in ppm), the unit can be based on the normalized window/interval, [0, 1] or [−1,1], 1 corresponds to freq. error value, e.g., specified in 38.104 (from RAN4). For example, 2^{N}^{_{F}} values within a window/interval, [0, 1] or [−1,1], x=FD unit length. In one example, x=0.05 ppm (parts per million).
   Note that CP length can be also expressed as

$$CP = \frac{144}{2056} \cdot \frac{1}{Δ f} \approx \frac{1}{14} \cdot \frac{1}{Δ f} ,$$

where Δf is subcarrier spacing, e.g., Δf=15, 30, 60, 120 (or etc) kHz. Or CP length can also be expressed as normal CP length or extended CP length, i.e., normal

$$CP length = \frac{144}{2056} \cdot \frac{1}{Δ f} \approx \frac{1}{14} \cdot \frac{1}{Δ f}$$

and extended

$$CP length = \frac{512}{2056} \cdot \frac{1}{Δ f} = \frac{1}{4} \cdot \frac{1}{Δ f} .$$

In this disclosure, CP length can be replaced by

$$\frac{144}{2056} \cdot \frac{1}{Δ f}$$

$$or$$

$${2}^{z} \times 4.69 \times 1 {0}^{- 6}$$

or an approximated CP length

$$\frac{1}{14} \cdot \frac{1}{Δ f}$$

or an extended

$$CP length \frac{1}{4} \cdot \frac{1}{Δ f} .$$

In one example, the CLI corresponds to at least one indicator indicating a measurement RS. For instance, the indicator can be CRI or SSB resource indicator (SSBRI) or other DL RS indicator when the measurement RS is NZP CSI-RS or SSB/PBCH block, or another DL RS. The at least one indicator can provide an implicit information about the offsets.

In one example, the CLI corresponds to the set of values of N or N−1 pairs {(δtᵣ,δfᵣ)} or indicator(s) indicating (quantized) values of {(δtᵣ,δfᵣ)}. At least one of the following examples of alphabet set is used for quantizing {(δtᵣ,δfᵣ)}.
In one example, the alphabet set corresponds to a uniform quantizer Qᵤₙᵢ in linear scale.
   In one example, Qᵤₙᵢ includes 2^{B} values, uniformly/equally spaced/separated in [0,v], where B is the number of bits for quantization and v is the max value. In one example, the 2^{B} values include 0 or/and v.
      In one example, for time, v=sT_{CP} where T_{CP} is the CP length, and s is a scaling. In one example, s=1.
      In one example, for time, v=sTₛₗₒₜ where Tₛₗₒₜ is the slot duration, and s is a scaling. In one example, s=1.
      In one example, for frequency, v=sFₘᵢₙ where Fₘᵢₙ is the min requirement on the frequency error, e.g. in parts per million (ppm).
   In one example, Qᵤₙᵢ includes 2^{B} values, uniformly/equally spaced/separated in [u,v] where B is the number of bits for quantization, u is the min value, and v is the max value. In one example, the 2^{B} values include u or/and v.
   In one example, Qᵤₙᵢ includes 2^{B} values, uniformly/equally spaced/separated in [−v/2,v/2].
In one example, the alphabet set corresponds to a uniform quantizer Qᵤₙᵢ in logarithmic scale.
In one example, the alphabet set corresponds to a non-uniform (e.g. exponential) quantizer Qₙₒₙ₋ᵤₙᵢ.
   In one example, Qₙₒₙ₋ᵤₙᵢ includes Rel.15 3-bit amplitude alphabet set (Table 1).
   In one example, Qₙₒₙ₋ᵤₙᵢ includes Rel.16 3-bit or 4-bit amplitude alphabet set (Table 2, Table 3).
   In one example, Qₙₒₙ₋ᵤₙᵢ includes Rel.18 amplitude alphabet set for time-domain channel property (TDCP) report (Table 4).

TABLE 1
Mapping of elements of k_{l, i}⁽¹⁾ to p_{l, i}⁽¹⁾

| k_{l, i}⁽¹⁾ | p_{l, i}⁽¹⁾ |
|---|---|
| 0 | 0 |
| 1 | \sqrt{1/64} |
| 2 | \sqrt{1/32} |
| 3 | \sqrt{1/16} |
| 4 | \sqrt{⅛} |
| 5 | \sqrt{¼} |
| 6 | \sqrt{½} |
| 7 | 1 |

TABLE 2
Mapping of elements of k_{l, i}⁽¹⁾ to p_{l, i}⁽¹⁾

| k_{l, p}⁽¹⁾ | p_{l, p}⁽¹⁾ |
|---|---|
| 0 | Reserved |
| 1 | $\frac{1}{\sqrt{128}}$ |
| 2 | ${( \frac{1}{8192} )}^{1 / 4}$ |
| 3 | ⅛ |
| 4 | ${( \frac{1}{2048} )}^{1 / 4}$ |
| 5 | $\frac{1}{2 \sqrt{8}}$ |
| 6 | ${( \frac{1}{512} )}^{1 / 4}$ |
| 7 | ¼ |
| 8 | ${( \frac{1}{128} )}^{1 / 4}$ |
| 9 | $\frac{1}{\sqrt{8}}$ |
| 10 | ${( \frac{1}{32} )}^{1 / 4}$ |
| 11 | ½ |
| 12 | ${( \frac{1}{8} )}^{1 / 4}$ |
| 13 | $\frac{1}{\sqrt{2}}$ |
| 14 | ${( \frac{1}{2} )}^{1 / 4}$ |
| 15 | 1 |

TABLE 3
Mapping of elements of k_{l, i}⁽¹⁾ to p_{l, i}⁽¹⁾

| k_{l, i, f}⁽²⁾ | p_{l, i, f}⁽²⁾ |
|---|---|
| 0 | $\frac{1}{8 \sqrt{2}}$ |
| 1 | ⅛ |
| 2 | $\frac{1}{4 \sqrt{2}}$ |
| 3 | ¼ |
| 4 | $\frac{1}{2 \sqrt{2}}$ |
| 5 | ½ |
| 6 | $\frac{1}{\sqrt{2}}$ |
| 7 | 1 |

TABLE 4
Mapping of elements kᵢ to aᵢ

| kᵢ | aᵢ |
|---|---|
| 0 | 1/256 |
| 1 | $\frac{1}{128 \sqrt{2}}$ |
| 2 | 1/128 |
| 3 | $\frac{1}{64 \sqrt{2}}$ |
| 4 | 1/64 |
| 5 | $\frac{1}{32 \sqrt{2}}$ |
| 6 | 1/32 |
| 7 | $\frac{1}{16 \sqrt{2}}$ |
| 8 | 1/16 |
| 9 | $\frac{1}{8 \sqrt{2}}$ |
| 10 | ⅛ |
| 11 | $\frac{1}{4 \sqrt{2}}$ |
| 12 | ¼ |
| 13 | $\frac{1}{2 \sqrt{2}}$ |
| 14 | ½ |
| 15 | $\frac{1}{\sqrt{2}}$ |

In one example, for delay reporting, the alphabet set includes at least one value corresponding to a value larger than the CP length.
In one example, the alphabet set includes 2^{B} values in [0, x, x₁] where x₁>x and here x is the CP length, as described herein.
In one example, the alphabet set includes 2^{B} values in [0, 1, x₁] (normalized by the CP length) where x₁>1 and here 1 corresponds to the CP length, as described herein.
In one example, the alphabet set includes 2^{B} values in [y, x, x₁] where 0<y, x₁>x and here x is the CP length, as described herein.
In one example, the alphabet set includes 2^{B} values in [y, 1, x₁] (normalized by the CP length) where 0<y, x₁>1 and here 1 corresponds to the CP length, as described herein.

In one example, for delay reporting, the alphabet set includes M>1 values corresponding to values larger than the CP length.
In one example, the alphabet set includes 2^{B} values in [0, x, x₁, . . . , x_{M}] where xₘ>x, m=1, . . . , M, and here x is the CP length, as described herein.
In one example, the alphabet set includes 2^{B} values in [0, 1, x₁, . . . , x_{M}] (normalized by the CP length) where xₘ>1, m=1, . . . , M, and here 1 corresponds to the CP length, as described herein.
In one example, the alphabet set includes 2^{B} values in [y, x, x₁, . . . , x_{M}] where 0<y, xₘ>x, m=1, . . . , M and here x is the CP length, as described herein.
In one example, the alphabet set includes 2^{B} values in [y, 1, x₁, . . . , x_{M}] (normalized by the CP length) where 0<y, xₘ>1, m=1, . . . , M and here 1 corresponds to the CP length, as described herein.

In one example, for delay reporting, the alphabet set includes at least one code point P indicating that delay value is larger than the CP length or corresponds to a value larger than the CP length.
In one example, the alphabet set includes 2^{B} values in [0, x, a] where x is the CP length, as described above. The code point P indicates a. In one example, a corresponds to NULL, Invalid, or a fixed value larger than x, or out-of-range.
In one example, the alphabet set includes 2^{B} values in [0, 1, a] (normalized by the CP length) where 1 corresponds to the CP length, as described above. The code point P indicates a. In one example, a corresponds to NULL, Invalid, or a fixed value larger than x or out-of-range.
In one example, the alphabet set includes 2^{B} values in [y, x, a] where 0<y, x is the CP length, as described above. The code point P indicates a. In one example, a corresponds to NULL, Invalid, or a fixed value larger than x or out-of-range.
In one example, the alphabet set includes 2^{B} values in [y, 1, a] (normalized by the CP length) where 0<y, 1 corresponds to the CP length, as described above. The code point P indicates a. In one example, a corresponds to NULL, Invalid, or a fixed value larger than x or out-of-range.

In one example, for delay reporting, the alphabet set includes at least one code point P indicating that delay value is larger than the CP length or corresponds to a value larger than the CP length, or/and includes M>1 values corresponding to values larger than the CP length.
In one example, the alphabet set includes 2^{B} values in [0, x, x₁, . . . , x_{M}, a] where x is the CP length and xₘ, as described above. The code point P indicates a. In one example, a corresponds to NULL, Invalid, or a fixed value larger than x or out-of-range.
In one example, the alphabet set includes 2^{B} values in [0, 1, x₁, . . . , x_{M}, a] (normalized by the CP length) where 1 corresponds to the CP length and xₘ, as described above. The code point P indicates a. In one example, a corresponds to NULL, Invalid, or a fixed value larger than x or out-of-range.
In one example, the alphabet set includes 2^{B} values in [y, x, x₁, . . . , x_{M}, a] where 0<y, x is the CP length and xₘ, as described above. The code point P indicates a. In one example, a corresponds to NULL, Invalid, or a fixed value larger than x or out-of-range.
In one example, the alphabet set includes 2^{B} values in [y, 1, x₁, . . . , x_{M}, a] (normalized by the CP length) where 0<y, 1 corresponds to the CP length and xₘ, as described above. The code point P indicates a. In one example, a corresponds to NULL, Invalid, or a fixed value larger than x or out-of-range.

In one example, M is fixed (e.g. 1). In one example, M is configured (e.g. RRC). In one example, M is reported by the UE.

In one example, x₁=x+δ, and δ is fixed (e.g.

$$\frac{1}{t}$$

and t is an integer), is configured (e.g. RRC), is reported by the UE.

In one example, xₘ=x+δₘ, and δₘ is fixed (e.g.

$$\frac{1}{{t}_{m}}$$

and tₘ is an integer), is configured (e.g. RRC), is reported by the UE.

In one example, for frequency error reporting, the alphabet set includes at least one value corresponding to a value larger than the frequency error (x).
In one example, the alphabet set includes 2^{B} values in [0, x, x₁] or [−x₁, −x, x, x₁] where x₁>x and here x is the the frequency error, as described above.
In one example, the alphabet set includes 2^{B} values in [0,1, x₁] or [−x₁, −1,1, x₁] (normalized by the the frequency error) where x₁>1 and here 1 corresponds to the the frequency error, as described above.
In one example, the alphabet set includes 2^{B} values in [y, x, x₁] where 0<y, x₁>x and here x is the the frequency error, as described above.
In one example, the alphabet set includes 2^{B} values in [y, 1, x₁] (normalized by the the frequency error) where 0<y, x₁>1 and here 1 corresponds to the the frequency error, as described above.

In one example, for frequency error reporting, the alphabet set includes M≥1 values corresponding to values larger than the the frequency error.
In one example, the alphabet set includes 2^{B} values in [0, x, x₁, . . . , x_{M}] where xₘ>x, m=1, . . . , M, and here x is the CP length, as described above.
In one example, the alphabet set includes 2^{B} values in [0, 1, x₁, . . . , x_{M}] (normalized by the Frequency error) where xₘ>1, m=1, . . . , M, and here 1 corresponds to the Frequency error, as described above.
In one example, the alphabet set includes 2^{B} values in [y, x, x₁, . . . , x_{M}] where 0<y, xₘ>x, m=1, . . . , M and here x is the Frequency error, as described above.
In one example, the alphabet set includes 2^{B} values in [y, 1, x₁, . . . , x_{M}] (normalized by the Frequency error) where 0<y, xₘ>1, m=1, . . . , M and here 1 corresponds to the Frequency error, as described above.

In one example, for frequency error reporting, the alphabet set includes at least one code point P indicating that delay value is larger than the Frequency error or corresponds to a value larger than the Frequency error.
In one example, the alphabet set includes 2^{B} values in [0, x, a] where x is the Frequency error, as described above. The code point P indicates a. In one example, a corresponds to NULL, Invalid, or a fixed value larger than x.
In one example, the alphabet set includes 2^{B} values in [0,1, a] (normalized by the Frequency error) where 1 corresponds to the Frequency error, as described above. The code point P indicates a. In one example, a corresponds to NULL, Invalid, or a fixed value larger than x.
In one example, the alphabet set includes 2^{B} values in [y, x, a] where 0<y, x is the Frequency error, as described above. The code point P indicates a. In one example, a corresponds to NULL, Invalid, or a fixed value larger than x.
In one example, the alphabet set includes 2^{B} values in [y, 1, a] (normalized by the Frequency error) where 0<y, 1 corresponds to the Frequency error, as described above. The code point P indicates a. In one example, a corresponds to NULL, Invalid, or a fixed value larger than x.

In one example, for frequency error reporting, the alphabet set includes at least one code point P indicating that delay value is larger than the Frequency error or corresponds to a value larger than the Frequency error, or/and includes M≥1 values corresponding to values larger than the Frequency error.
In one example, the alphabet set includes 2^{B} values in [0, x, x₁, . . . , x_{M}, a] where x is the Frequency error and xₘ, as described above. The code point P indicates a. In one example, a corresponds to NULL, Invalid, or a fixed value larger than x.
In one example, the alphabet set includes 2^{B} values in [0,1, x₁, . . . , x_{M}, a] (normalized by the Frequency error) where 1 corresponds to the Frequency error and xₘ, as described above. The code point P indicates a. In one example, a corresponds to NULL, Invalid, or a fixed value larger than x.
In one example, the alphabet set includes 2^{B} values in [y, x, x₁, . . . , x_{M}, a] where 0<y, x is the Frequency error and xₘ, as described above. The code point P indicates a. In one example, a corresponds to NULL, Invalid, or a fixed value larger than x.
In one example, the alphabet set includes 2^{B} values in [y, 1, x₁, . . . , x_{M}, a] (normalized by the Frequency error) where 0<y, 1 corresponds to the Frequency error and xₘ, as described above. The code point P indicates a. In one example, a corresponds to NULL, Invalid, or a fixed value larger than x.

In one example, M is fixed (e.g. 1). In one example, M is configured (e.g. RRC). In one example, M is reported by the UE.

In one example, x₁=x+δ, and δ is fixed (e.g.

$$\frac{1}{t}$$

and t is an integer), is configured (e.g. RRC), is reported by the UE.

In one example, xₘ=x+δₘ, and δₘ is fixed (e.g.

$$\frac{1}{{t}_{m}}$$

and tₘ is an integer), is configured (e.g. RRC), is reported by the UE.

In one example, the alphabet set includes codepoints, where the codepoints indicate uniformly quantized frequency offset values (or intervals) between—A_{FO} and A_{FO}. In one example, A_{FO} corresponds to x_{M} in an example shown in this disclosure.

In one example, the alphabet set includes codepoints, where the codepoints indicate uniformly quantized frequency offset values (or intervals) between 0 and A_{FO}. In one example, A_{FO} corresponds to x_{M} in an example shown in this disclosure.

In one example, the CLI corresponds to the set of values of N−1 phases {ϕᵣ} associated with (or due to) {(δtᵣ,δfᵣ)} or indicator(s) indicating (quantized) values of {ϕᵣ}. In one example, ϕᵣ e^{j2π(f+δf}^{ᵣ}^{)(t+δt}^{ᵣ}⁾. At least one of the following examples of the alphabet set is used for quantizing {(δtᵣ,δfᵣ)}. In one example, the alphabet set corresponds 2^{e}=N_{PSK} bit alphabet set.
In one example, e=1. The 2 values corresponds to binary phase-shift keying (BPSK) [1, −1].
In one example, e=2. The 4 values corresponds to QPSK [1, j, −1, −j].
In one example, e=3. The 8 values corresponds to 8 PSK

$$\{ {e}^{j \frac{2 π k}{8}} : k = 0 , 1 , ... , 7 \} .$$

In one example, e=4. The 16 values corresponds to 16 PSK

$$\{ {e}^{j \frac{2 π k}{16}} : k = 0 , 1 , ... , 15 \} .$$

In one example, e is configured via higher layer signaling, e.g. from {3,4}.

In one example, the UE also reports (indices indicating) the values of {(δtᵣ,δfᵣ)} associated with the reported {ϕᵣ}. In one example, the UE is configured with (indices indicating) the values of {(δtᵣ,δfᵣ)}.

In one example, the CLI can also include amplitude in addition to phase, i.e., cᵣ=aᵣϕᵣ.

At least one of the following examples is used/configured regarding the reporting/calculation.

In one example, the reporting is absolute, i.e., each of N values is determined/reported independently from other values.

In one example, the reporting is differential (relative) with respect to a base or reference. In one example, the based or reference is r=0, the 1^{st} TRP (resource). That is, the offset value corresponding to r>0 is reported/determined w.r.t. to the same corresponding to r=0. In one example, the reference can be fixed (e.g. 0), or configured (e.g. via higher layer) or reported by the UE (as part of the CSI report, either via part 1 or part 2 of a two-part UCI). In one example, the normalized value of the reference can also be reported by the UE.
In one example, the differential/relative offset value is determined as v′(r)=v(r)−v(0). The UE reports correlation v(0) for r=0, and c′(v) for v≠0.
In one example, the differential/relative offset is determined as

$${v}^{′} ( r ) = \frac{v ( r )}{v ( 0 )} .$$

The UE (e.g., the UE 116) reports offset v(0) for r=0, and v′(r) for r≠0.
In one example, vₜ=vₜ₋₁+\tilde{v}ₜ or vₜ=vₜ₋₁×\tilde{v}ₜ.
In one example, vₜ=V₀+\tilde{v}ₜ or vₜ=v₀×\tilde{v}ₜ.

In one example, the report is a standalone/separate report (similar to Rel.18 time-domain channel property, TDCP), and doesn't include any other parameters. The report can be reported via a layer 1 (physical) UL channel such as PUCCH or/and PUSCH. In this case, the report can be multiplexed with other UCI parameters such as HARQ-ACK parameters. Alternatively, the report can be reported via a layer 2 (MAC) UL channel such as UL MAC CE. In this case, the report can be multiplexed with other MAC parameters such as PHR parameters.

In one example, the report is a non-standalone/joint report and can include other parameters such as CSI parameters (e.g. rank indicator (RI), precoding matrix indicator (PMI), channel quality indicator (CQI), CQI report interval (CRI), layer index (LI))) or/and beam-related parameters (e.g. layer 1 reference signal received power (L1-RSRP), layer 1 signal-to-interference-plus-noise ratio (L1-SINR), CRI, SSBRI). In this case, the (calibration) report is a component (or part of) out of multiple components (or parts of) the CSI/beam report.

In one example, the CLI can be included as a component of (part of an alphabet set), e.g. Rel.18 Type II CJT alphabet set, and the corresponding configuration can be codebookMode=mode 3 (in addition to mode 1 and mode 2 in Rel.18).

In one example, a metric to obtain/derive/obtain the CLI is based on auto-(/cross-) correlation or/and power spectrum or power spectrum density of the measurement.

In one example, the measurement and reporting for T-F offset is decoupled/separate, i.e., one of the two separate mechanisms can be configured/used.
For time offset (δtᵣ), the measurement corresponds to multiple (a burst of) time occasions, where two consecutive time occasions can be separated by d symbols or slots.
For frequency offset (δfᵣ), the measurement corresponds to multiple (a burst of) frequency occasions, where two consecutive frequency occasions can be separated by d subcarriers or PRBs or subbands (SBs).

In one example, the measurement and reporting for T-F offset is coupled/joint, i.e., one joint mechanism is used/configured for a 2D measurement and reporting for (δtᵣ,δfᵣ).

At least one of the following examples is used/configured regarding the frequency domain granularity of the reporting/calculation of offset value(s).
In one example, the reporting/calculation of offset value(s) is in a wideband (WB) manner, i.e., offset values are reported common for the entire CSI reporting band.
In one example, the reporting/calculation of offset value(s) is in a subband (SB) manner, i.e., offset values are reported for each SB in the CSI reporting band. In addition, a reference (WB) offset can also be reported such that Sub-band offset level (s)=sub-band offset index (s)−wideband offset index.

Likewise, at least one of the following examples is used/configured regarding the time domain granularity of the reporting/calculation of offset value(s).
In one example, the reporting/calculation of offset value(s) is in a wide-time (WT) manner, i.e., offset values are reported common for the entire time window or duration (in which the report is expected to be valid).
In one example, the reporting/calculation of offset value(s) is in a sub-time (ST) manner, i.e., offset values are reported for each ST in the time duration (in which the report is expected to be valid). In addition, a reference (WT) offset can also be reported such that ST offset level (s)=ST offset index (s)−WT offset index.

In one example, the report includes one value for each TRP (N values when including the reference or N−1 values when excluding the reference). For time/delay offsets (Dᵣ delay values d_{r,0}, . . . , d_{r,D}_{ᵣ}₋₁ sorted in increasing order)
In one example, the one value corresponds to the 1^{st} delay d_{r,0}.
In one example, the one value corresponds to the last delay d_{r,D}_{ᵣ}₋₁.
In one example, the one value corresponds to the max of {d_{r,i}_{ᵣ}}, iᵣ=0, . . . , Dᵣ−1.
In one example, the one value corresponds to the Delay spread DSᵣ=d_{r,D}_{ᵣ}₋₁−d_{r,0}.

Likewise, for frequency offsets (Fᵣ values f_{r,0}, . . . , f_{r,F}_{ᵣ}₋₁ sorted in increasing order)
In one example, the one value corresponds to the 1^{st} frequency f_{r,0}.
In one example, the one value corresponds to the last frequency f_{r,F}_{ᵣ}₋₁.
In one example, the one value corresponds to the max of {f_{r,i}_{ᵣ}}, iᵣ=0, . . . , Fᵣ−1.
In one example, the one value corresponds to the Frequency spread FSᵣ=f_{r,F}_{ᵣ}₋₁−f_{r,0}.

In one example, the report includes two values for each TRP. For time/delay offsets (Dᵣ delay values d_{r,0}, . . . , d_{r,D}_{ᵣ}₋₁ sorted in increasing order),
In one example, the two values can correspond to the 1^{st} and the last values d_{r,0} and d_{r,D}_{ᵣ}₋₁.
In one example, the two values can correspond to the max and the min of {d_{r,i}_{ᵣ}}, iᵣ=0, . . . , Dᵣ−1.
In one example, the two values can correspond to the two largest values of {d_{r,i}_{ᵣ}}, iᵣ=0, . . . , Dᵣ−₁.

Likewise, For frequency offsets (Fᵣ values f_{r,0}, . . . , f_{r,F}_{ᵣ}₋₁ sorted in increasing order),
In one example, the two values can correspond to the 1^{st} and the last values f_{r,0} and f_{r,F}_{ᵣ}₋₁.
In one example, the two values can correspond to the max and the min of {f_{r,i}_{ᵣ}}, iᵣ=0, . . . , Fᵣ−1.
In one example, the two values can correspond to the two largest values of {f_{r,i}_{ᵣ}}, iᵣ=0, . . . , Fᵣ−1.

In one example, the report includes two values for each TRP.

In one example, the report includes two values for N−1 TRPs (excluding the reference TRP).

In one example, the report includes one value V_{ref} for the reference TRP, and two values for remaining TRPs, i.e., the two values for the reference are 0 and V_{ref}.

In one example, the report further includes a recommendation about coherency (CJT or NCJT) across TRPs. In one example, it can be implicit via one value, or explicit via an indicator (e.g. 1-bit), or via an Nₜᵣₚ-bit or N-bit bitmap indicator, where when the bitmap is ‘0’ or ‘1’ then it indicates NCJT and when at least two ‘1’s or ‘0’s then it indicates CJT.

Various embodiments provide for reference TRP information. In one embodiment, a CLI reporting (described in an example of embodiments herein) is according to at least one of the following examples.

In one example, the CLI reporting includes one CRI (or DL RS indicator or an indicator) to indicate a reference CSI-RS resource out of Nₜᵣₚ or N CSI-RS resources.

In one example, the CLI reporting does not include any CRI information.
In one example, a reference CSI-RS resource can be configured by the NW, via higher-layer signaling (i.e., RRC).
In one example, a reference CSI-RS resource is fixed, e.g., the lowest (or highest) index of CSI-RS resources.
In one example, a reference CSI-RS resource is not indicated/reported/specified/used.

In one example, the CLI reporting includes a Nₜᵣₚ-bit bitmap indicator (or N≤Nₜᵣₚ-bit bitmap indicator) to indicate one or multiple CSI-RS resources.

Various embodiments provide quantization scheme for delay. In one embodiment, for (inter-TRP-)delay reporting (of a CLI reporting described in an example of embodiment I), an alphabet set for quantizing delay values is according to at least one of the following examples.

In one example, the alphabet set includes 0 value or a codepoint mapping to 0 value.

In one example, the alphabet set does not include 0 value or a codepoint mapping to 0 value.

In one example, the alphabet set includes 2^{B} values or codepoints for a range of [y,xₘₐₓ] in unit of CP length, where y can be fixed, e.g., y=1, or y<1, or y>1, or can be configured by the NW via higher-layer signaling (i.e., RRC), or can be determined by the UE, and where xₘₐₓ>y is a maximum value of the range (e.g., xₘₐₓ=1.2, 1.3, 1.4, 1.5, 1.6, 1.7, 1.8, 1.9, or 2) and it can be fixed, configured by the NW, or determined by the UE.
In one example, B=0, 1, 2, 3, or 4 is fixed. In another example, B can be configured by the NW. In another example, B can be determined by the UE and reported as a part of the reporting.
In one example, the 2^{B} values (or codepoints) are values in [y,xₘₐₓ] in unit of CP length.
In one example, the 2^{B} values (or codepoints) are values in [0,xₘₐₓ−y] in unit of CP length.
In one example, the 2^{B} values (or codepoints) includes 0 value.
In one example, the 2^{B} values (or codepoints) includes a reserved value, e.g., NULL, out-of-range, etc.

In one example, more specifically, the alphabet set includes 2^{B}=M codepoints where M−1 codepoints correspond to intervals in [0, A_{D}] in unit of CP length (where A_{D}−xₘₐₓ−y) and 1 codepoint corresponds to a reserved value (e.g., out-of-range, invalid state, NULL, etc). In one example, each codepoint i of the M−1 codepoints corresponds to an interval [δᵢ,δᵢ₊₁) (or (δᵢ, δᵢ₊₁], [δᵢ, δᵢ₊₁], or (δᵢ,δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0, 1, 2, . . . , M−1. The reserved value (e.g., out-of-range) can represent [A_{D}, ∞).

In one example, each codepoint i of the M−1 (or M−2) codepoints corresponds to an interval [δᵢ,δᵢ₊₁) (or (δᵢ, δᵢ₊₁], [δᵢ, δᵢ₊₁], or (δᵢ,δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0, 1, 2, . . . , M−2. The reserved value (e.g., out-of-range) can represent [A_{D}, ∞).

In one example, the alphabet set includes 2^{B} values or codepoints for a range of [y,xₘₐₓ] in (absolute) time unit, where y can be fixed, e.g., y=1×CP length, or y<1×CP length, or y>1×CP length, or can be configured by the NW via higher-layer signaling (i.e., RRC), or can be determined by the UE, and where xₘₐₓ>y is a maximum value of the range (e.g., xₘₐₓ=a value less than 1, 1, 1.1, 1.2, 1.3, 1.4, 1.5, 1.6, 1.7, 1.8, 1.9, 2, 2.5, 3, a value larger than 3×CP), and it can be fixed, configured by the NW, or determined by the UE.
In one example, B=0, 1, 2, 3, 4, 5, 6, 7, or 8 or a larger value than 8 is fixed. In another example, B can be configured by the NW. In another example, B can be determined by the UE and reported as a part of the reporting.
In one example, the 2^{B} values (or codepoints) are values in [y,xₘₐₓ] in (absolute) time unit.
In one example, the 2^{B} values (or codepoints) are values in [0,xₘₐₓ−y] in (absolute) time unit
In one example, the 2^{B} values (or codepoints) includes 0 value.
In one example, the 2^{B} values (or codepoints) includes a reserved value, e.g., NULL, out-of-range, etc.

In one example, more specifically, the alphabet set includes 2^{B}=M codepoints where M−1 codepoints correspond to intervals in [0, A_{D}] in (absolute) time unit (where A_{D}=xₘₐₓ−y) and 1 codepoint corresponds to a reserved value (e.g., out-of-range, invalid state, NULL, etc). In one example, each codepoint i of the M−1 codepoints corresponds to an interval [δᵢ,δᵢ₊₁) (or (δᵢ, δᵢ₊₁], [δᵢ, δᵢ₊₁], or (δᵢ,δᵢ₊₁)), where {δ₀, δ₁, . . . , δ_{M-1}} is uniformly spaced between 0 and A_{D},

$${δ}_{i} = i \times \frac{{A}_{D}}{M - 1} ,$$

for i=0, 1, 2, . . . , M−1. The reserved value (e.g., out-of-range) can represent [A_{D}, ∞) (or (A_{D}, ∞)).

In one example, each codepoint i of the M−1 (or M−2) codepoints corresponds to an interval [δᵢ,δᵢ₊₁) (or (δᵢ, δᵢ₊₁], [δᵢ, δᵢ₊₁], or (δᵢ,δᵢ₊₁)), where {δ₀, δ₁, . . . , δ_{M-2}} is uniformly spaced between 0 and A_{D},

$${δ}_{i} = i \times \frac{{A}_{D}}{M - 2} ,$$

for i=0, 1, 2, . . . , M−2. The reserved value (e.g., out-of-range) can represent [A_{D}, ∞).

In an embodiment, for delay reporting (of a CLI reporting described in an example of embodiment I), one or multiple delay values for each of Nₜᵣₚ (or N≤Nₜᵣₚ) CSI-RS resource or each of Nₜᵣₚ−1 (or N−1) CSI-RS resources are reported as a part of CLI reporting.

Various embodiments provide for the case of # of delays=1 for reporting. In one embodiment, one delay value for CSI-RS resource r is quantized using at least one of the schemes described in embodiments herein.
In one example, one delay value for each of Nₜᵣₚ (or N≤Nₜᵣₚ) CSI-RS resources is quantized and indicated by a (separate) per-TRP (i.e., per-CSI-RS resource) indicator.
In one example, one delay value for each of Nₜᵣₚ−1 (or N−1) CSI-RS resources is quantized and indicated by a (separate) per-TRP (i.e., per-CSI-RS resource) indicator.
In one example, one delay value for each of Nₜᵣₚ (or N≤Nₜᵣₚ) CSI-RS resources is quantized and the Nₜᵣₚ delay values are indicated by a joint indicator.
In one example, one delay value for each of Nₜᵣₚ−1 (or N−1) CSI-RS resources is quantized and the Nₜᵣₚ−1 delay values are indicated by a joint indicator.

Various embodiments provide for case of # of delays=2 for reporting. In one embodiment, each of two delay values (e.g., first delay tap and last delay tap) for CSI-RS resource r is quantized using at least one of the schemes described in embodiment I or embodiment I.1.2.
In one example, each of two delay values for each of Nₜᵣₚ (or N≤Nₜᵣₚ) CSI-RS resources is quantized and indicated via a (separate) per-TRP (i.e., per-CSI-RS resource) indicator.
In one example, each of two delay values for each of Nₜᵣₚ−1 (or N−1) CSI-RS resources is quantized and indicated via a (separate) per-TRP (i.e., per-CSI-RS resource) indicator.
In one example, each of two delay values for each of Nₜᵣₚ (or N≤Nₜᵣₚ) CSI-RS resources is quantized and the 2Nₜᵣₚ delay values are indicated via a joint indicator.
In one example, each of two delay values for each of Nₜᵣₚ−1 (or N−1) CSI-RS resources is quantized and the 2(Nₜᵣₚ−1) delay values are indicated via a joint indicator.

In one example, for the two delay values, D₁ and D₂ (where D₁<D₂), for CSI-RS resource r, alphabet sets [symbol] and [symbol] for the two delay values are the same, i.e., D₁ and D₂ are quantized using a same alphabet set, where the alphabet set is one of the examples described in embodiments herein.

In one example, for the two delay values, D₁ and D₂ (where D₁<D₂), for CSI-RS resource r, alphabet sets [symbol] and [symbol] for the two delay values can be different, i.e., D₁ and D₂ are quantized using different alphabet sets [symbol] and [symbol] , respectively, where each of the alphabet sets is one of the examples described in embodiments herein.

In one example, the number of bits B for alphabet sets [symbol] and [symbol] can be the same, but the alphabet sets [symbol] and [symbol] can be different.

In one example, the number of bits B for alphabet sets [symbol] and [symbol] can be different, where B₁ and B₂ are the numbers of bits for alphabet sets [symbol] and [symbol] , respectively, and B₁>B₂.
In one example, B₁>1 and B₂=1, where D₁ is quantized/indicated using alphabet set with B₁ bits and D₂ is indicated by an 1-bit indicator, whether D₂ (which can correspond to delay spread) is exceeding CP length or not, or exceeding a threshold value or not, or out-of-range or not, or ON or OFF, etc.
In one example, B₁>1 and B₂=1, where D₁ is quantized/indicated using alphabet set with B₁ bits and D₂ is indicated/quantized using alphabet set with 1-bit, e.g., having x₁ and x₂ values.
In one example, B₁>B₂ and B₂>1, where D₁ is quantized/indicated using alphabet set with B₁ bits and D₂ is indicated/quantized using alphabet set with B₂ bits.

In one example, the number of bits B for alphabet sets [symbol] and [symbol] can be different, where B₁ and B₂ are the numbers of bits for alphabet sets [symbol] and [symbol] , respectively, and B₁<B₂.
In one example, B₁=1 and B₂>1, where D₂ is quantized/indicated using alphabet set with B₂ bits and D₁ is indicated by an 1-bit indicator, whether D₁ (which can correspond to delay spread) is exceeding CP length or not, or exceeding a threshold value or not, or out-of-range or not, or ON or OFF, etc.
In one example, B₁=1 and B₂>1, where D₂ is quantized/indicated using alphabet set with B₂ bits and D₁ is indicated/quantized using alphabet set with 1-bit, e.g., having x₁ and x₂ values.
In one example, B₁>1 and B₂>B₁, where D₂ is quantized/indicated using alphabet set with B₂ bits and D₁ is indicated/quantized using alphabet set with B₁ bits.

In above examples for the two delay values, D₁ and D₂ can be referring to at least one of the following examples.
In one example, D₁ corresponds to a first delay tap/offset and D₂ corresponds to a last delay tap/offset.
In one example, D₁ corresponds to a first delay tap/offset and D₂ corresponds to differential/relative delay value to the first delay tap. In this case, a last delay tap/offset can be expressed as D₁+D₂.
In one example, D₁ corresponds to a first delay tap/offset and D₂ corresponds to delay spread. In this case, a last delay tap/offset can be expressed as D₂−D₁.
In one example, D₂ corresponds to a last delay tap/offset and D₁ corresponds to delay spread. In this case, a first delay tap/offset can be expressed as D₂−D₁.
In one example, D₁ and D₂ are represented in the unit of CP length (i.e., normalized by CP length).
In one example, D₁ and D₂ are represented in absolute time unit (without normalization).
In one example, D₁ and D₂ are represented in the unit of OFDM-symbol/slot time unit (normalized by OFDM symbol/slot duration).

In one example, a payload of indicating for a first delay value is given by (Nₜᵣₚ−1)B₁ and a payload of indicating for a second delay value is given by (Nₜᵣₚ−1)B₂.

In one example, a payload of indicating for a first delay value is given by NₜᵣₚB₁ and a payload of indicating for a second delay value is given by NₜᵣₚB₂.

Various embodiments provided for the case of # of delays>2 (extension) for reporting. In one embodiment, each of T>2 delay values for CSI-RS resource r is quantized using at least one of the schemes described in embodiments herein.
In one example, each of T delay values for each of Nₜᵣₚ (or N≤Nₜᵣₚ) CSI-RS resources is quantized and indicated via a (separate) per-TRP (i.e., per-CSI-RS resource) indicator.
In one example, each of T delay values for each of Nₜᵣₚ−1 (or N−1) CSI-RS resources is quantized and indicated via a (separate) per-TRP (i.e., per-CSI-RS resource) indicator.
In one example, each of T delay values for each of Nₜᵣₚ (or N≤Nₜᵣₚ) CSI-RS resources is quantized and the 2Nₜᵣₚ delay values are indicated via a joint indicator.
In one example, each of T delay values for each of Nₜᵣₚ−1 (or N−1) CSI-RS resources is quantized and the 2(Nₜᵣₚ−1) delay values are indicated via a joint indicator.

In one example, for the T delay values, D₁, D₂, . . . D_{T} (where D₁<D₂< . . . <D_{T}), for CSI-RS resource r, alphabet sets [symbol] , . . . , [symbol] for the T delay values are the same, i.e., D₁, D₂, . . . D_{T} are quantized using a same alphabet set, where the alphabet set is one of the examples described in embodiments herein.

In one example, for the T delay values, D₁, D₂, . . . D_{T} (where D₁<D₂< . . . <D_{T}), for CSI-RS resource r, alphabet sets [symbol] , . . . , [symbol] for the T delay values can be different, i.e., D₁, D₂, . . . D_{T} are quantized using different alphabet sets [symbol] , . . . , [symbol] , respectively, where each of the alphabet sets is one of the examples described in embodiments herein.

In one example, the number of bits B for alphabet sets [symbol] , . . . , [symbol] , Ur can be the same, but the alphabet sets [symbol] , . . . , [symbol] can be different.

In one example, the number of bits B for alphabet sets [symbol] , . . . , [symbol] can be different, where B₁, B₂ . . . B_{T} are the numbers of bits for alphabet sets [symbol] , . . . , [symbol] respectively.

In one example, a payload of indicating for a i-th delay value is given by (Nₜᵣₚ−1)Bᵢ for i=1, 2, . . . , T.

In one example, a payload of indicating for a i-th delay value is given by NₜᵣₚBᵢ for i=1, 2, . . . , T.

In embodiment, the number of bits B for alphabet set [symbol] , as described in this disclosure, can be according to at least one of the following examples.

In one example, B (or B₁, B₂) is CSI-RS-resource-common, i.e., a same bit is used across all configured CSI-RS resources.

In one example, Bᵣ (or B_{1,r}, B_{2,r}) is CSI-RS-resource-specific, i.e., a different/independent bit is used across for each configured CSI-RS resource r.

In one example, B depends on the number of CSI-RS resources, i.e., N_{TRP} (or N). For example, B=cN_{TRP}, with a scaling value of c.

In one example, B is fixed or configured by NW, or determined by UE and reported as a part of reporting.

In one embodiment, a UE can be configured with a range value of A_{D} and/or a number of quantization states M (or a number of bits B for quantization states (where M=2^{B})) for CJT delay reporting (or frequency reporting, or phase offset reporting or other joint reporting). Here, the CJT delay reporting can be a delay reporting scheme designed based on an example described in/under embodiments herein. In one example, A_{D} and M (or B) can be designed at least one of the following examples.

In one example, A_{D} can be configurable by NW via RRC signaling (or MAC-CE or DCI).

In one example, M (or B) can be configurable by NW via RRC signaling (or MAC-CE or DCI).

In one example, A_{D} and M (or B) can be separately indicated/configured with separate parameters.

In one example, A_{D} and M (or B) can be jointly indicated/configured with separate parameters.

In one example, the number of supported values of A_{D} is N_{A}. In one example, N_{A}=4. In one example, N_{A}=3. In one example, N_{A}=2. In one example, N_{A}>4. In one example, N_{A}<4.

In one example, the number of supported values of M (or B) is N_{M}. In one example, N_{M}4. In one example, N_{M}=3. In one example, N_{M}>4. In one example, N_{M}<4.

In one example, the number of supported values of (A_{D},M) or (A_{D},B) is Np. In one example, N_{J}=4. In one example, N_{J}=3. In one example, N_{J}>4. In one example, N_{J}<4.

In one example, one of the configurable values of A_{D} corresponds to CP length.

In one example, one of the configurable values of A_{D} corresponds to a value smaller than CP length. In one example, A_{D} corresponds to c×CP, where c<1 e.g., c=0.5 or 0.3 or ⅓.

In one example, one of the configurable values of A_{D} corresponds to a value larger than CP length. In one example, A_{D} corresponds to c×CP, where c>1 e.g., c=1.5 or 1.8 or 2.

In one example, one of the configurable values of M (or B) corresponds to 32 (i.e., B=5 bits).

In one example, one of the configurable values of M (or B) corresponds to a value smaller than 32. In one example, M corresponds to 16 or 8 or 4 or 2.

In one example, one of the configurable values of M (or B) corresponds to a value larger than 32. In one example, M corresponds to 64 or 128 or 256.

In one example, one of the configurable values of (A_{D}, M) (or (A_{D}, B)) corresponds to (CP length, 32).

In one example, one of the configurable values of (A_{D}, M) (or (A_{D}, B)) corresponds to (CP length, X), where X corresponds to a value smaller than 32.

In one example, one of the configurable values of (A_{D}, M) (or (A_{D}, B)) corresponds to (CP length, X), where X corresponds to a value larger than 32.

In one example, one of the configurable values of (A_{D}, M) (or (A_{D}, B)) corresponds to (c×CP length, 16), where c<1, e.g., c=0.5 or 0.3 or ⅓.

In one example, one of the configurable values of (A_{D}, M) (or (A_{D}, B)) corresponds to (c×CP length, X), where c<1, e.g., c=0.5 or 0.3 or ⅓, and X corresponds to a value larger than 16.

In one example, one of the configurable values of (A_{D}, M) (or (A_{D}, B)) corresponds to (c×CP length, X), where c<1, e.g., c=0.5 or 0.3 or ⅓, and X corresponds to a value smaller than 16.

In one example, one of the configurable values of (A_{D}, M) (or (A_{D}, B)) corresponds to (c×CP length, 32), where c>1, e.g., c=1.5 or 1.8 or 2.

In one example, one of the configurable values of (A_{D}, M) (or (A_{D}, B)) corresponds to (c×CP length, X), where c>1, e.g., c=1.5 or 1.8 or 2, and X corresponds to a value larger than 32.

In one example, one of the configurable values of (A_{D}, M) (or (A_{D}, B)) corresponds to (c×CP length, X), where c>1, e.g., c=1.5 or 1.8 or 2, and X corresponds to a value smaller than 32.

In one example, CP length described in this disclosure corresponds to

$$\frac{144}{2056} \cdot \frac{1}{Δ f} or {2}^{z} \times 4.69 \times {10}^{- 6} or \frac{1}{14} \cdot \frac{1}{Δ f} or \frac{1}{4} \cdot \frac{1}{Δ f} ,$$

where Δf is subcarrier spacing (e.g., 15, 30, 60, 120, 240 kHz) and z∈{0, 1, 2, 3, 4}.

In one example, one of the configurable values of A_{D} corresponds to a function of a PMI subband size

$$( e . g . , \frac{x}{Δ {f}_{PMI}} ) ,$$

where the PMI subband size can be calculated based on the number of RBs per PMI subband, e.g.,

$$Δ {f}_{PMI} = {N}_{PRB}^{SB} \times {N}_{sc}^{RB} \times Δ f \times \frac{1}{R} ,$$

where N_{PRB}^{SB} is the number of RBs per CQI subband, N_{sc}^{RB} is the number of subcarriers per RB, Δf is subcarrier spacing, and R is the number of precoding matrix (PMIs) per CQI subband.
In one example, each example shown in the above with replacing the CP by a function of a PMI subband size can be another example.
In one example, the maximum (configurable) value of M (or B) can be determined based on the maximum configurable value N₃ (up to 38) and O₃ (in {1,4}), e.g., N₃O₃ is up to 152. For example, M (or B) does not exceed 256 (or 8 bits).

In one example, one of the configurable values of A_{D} corresponds to a function of reference signal spacing (RS frequency density) in frequency-domain

$$( e . g . , \frac{1}{12 Δ f} , \frac{3}{12 Δ f} )$$

or RB size or subcarrier spacing.
In one example, each example shown in the above with replacing the CP by a function of reference signal spacing in frequency-domain or RB size or subcarrier spacing can be another example.

$$( e . g . , c \times \frac{1}{12 Δ f} )$$

In one example, A_{D} can be determined based on a value of multiples of a step size, where the step size can be determined by a configured band-width-part (BWP) (in associated CSI-RS resource/resource set measurement), and the multiples can be given by 2^{B}−1 (i.e., M−1). In one example, a range value of A_{D} can be implicitly configured by NW via RS configuration for measurement and a number of quantization states M (or a number of bits B for quantization states (where M=2^{B})) is only configured.

In one example, a UE is not expected to be configured with A_{D} where the value of A_{D} exceeds a measurable delay value from associated CSI-RS resource/resource set. The measurement delay value can be determined RS density in frequency (spacing between two resource allocation of the RS (e.g., TRS RE density, such as 1 RE/RB/port, 3 RE/RB/port).

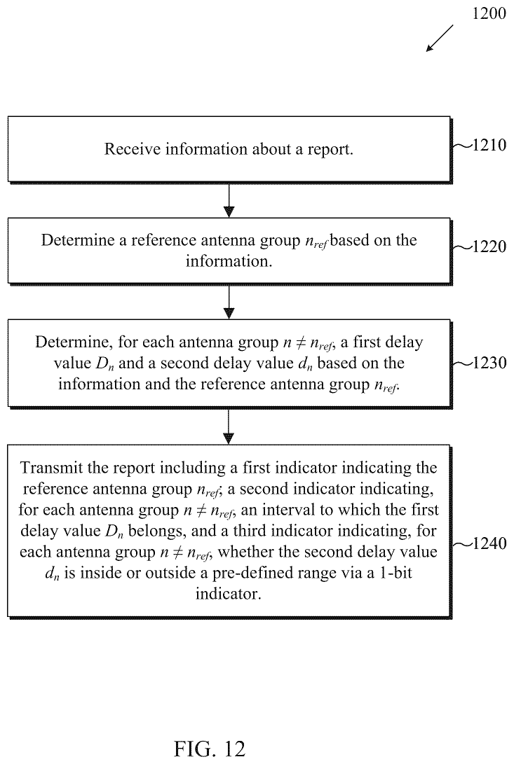

FIG. 12 illustrates an example method 1200 performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE receiving information about a report (1210). For example, in 1210, the information indicates N_{TRP} antenna groups. In various embodiments, each antenna group of the N_{TRP} antenna groups corresponds to a respective CSI-RS resource set or a respective CSI-RS resource.

The UE then determines a reference antenna group n_{ref} based on the information (1220). The UE then determines, for each antenna group n≠n_{ref}, a first delay value Dₙ and a second delay value dₙ based on the information and the reference antenna group n_{ref} (1230).

The UE then transmits the report including a first indicator indicating the reference antenna group n_{ref}, a second indicator indicating, for each antenna group n≠n_{ref}, an interval to which the first delay value Dₙ belongs, and a third indicator indicating, for each antenna group n≠n_{ref}, whether the second delay value dₙ is inside or outside a pre-defined range via a 1-bit indicator (1240). In various embodiments, the pre-defined range corresponds to [0, 1CP], where the 1CP corresponds to a 1 CP length.

In various embodiments, the interval is indicated by an indicator of size B bits with an alphabet set, where the alphabet set includes M=2^{B} codepoints and the 2^{B} codepoints correspond to 2^{B}−1 equally-spaced intervals in [0, A_{D}] and an ‘out-of-range’ codepoint, where A_{D}>0. In some examples, an i-th interval of the 2^{B}−1 equally-spaced intervals in [0, A_{D}] is given by [δᵢ,δᵢ₊₁] for i=0, 1, . . . , M−2, where

$${δ}_{i} = i \times \frac{{A}_{D}}{M - 1}$$

and the ‘out-of-range’ codepoint corresponds to [A_{D}, ∞). In some examples, a value of M∈ [symbol] is configured via a RRC parameter, where [symbol] is a set including 32, 64, 128, and 256. In some examples, a value of A_{D}∈ [symbol] is configured via a RRC parameter, where [symbol] is a set including 0.5 CP length and 1 CP length. In some examples, a payload of the second indicator is given by (N_{TRP}−1)B bits and a payload of the third indicator is given by (N_{TRP}−1) bits.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about a report, the information indicating N_{TRP} antenna groups, where N_{TRP}>1; and
a processor operably coupled to the transceiver, the processor configured to:
determine, based on the information, a reference antenna group n_{ref}; and
determine, based on the information and the reference antenna group n_{ref}, for each antenna group n≠n_{ref}, a first delay value Dₙ and a second delay value dₙ,
wherein the transceiver is further configured to transmit the report including:
a first indicator indicating the reference antenna group n_{ref};
a second indicator indicating, for each antenna group n≠n_{ref}, an interval to which the first delay value Dₙ belongs; and
a third indicator indicating, for each antenna group n≠n_{ref}, whether the second delay value dₙ is inside or outside a pre-defined range via a 1-bit indicator.

2. The UE of claim 1, wherein each antenna group of the N_{TRP} antenna groups corresponds to a respective CSI reference signal (CSI-RS) resource set or a respective CSI-RS resource.

3. The UE of claim 1, wherein the pre-defined range corresponds to [0, 1CP], where the 1CP corresponds to a 1 cyclic prefix (CP) length.

4. The UE of claim 1, wherein:
the interval is indicated by an indicator of size B bits with an alphabet set, where:
the alphabet set includes M=2^{B} codepoints; and
the 2^{B} codepoints correspond to 2^{B}−1 equally-spaced intervals in [0, A_{D}] and an ‘out-of-range’ codepoint, where A_{D}>0.

5. The UE of claim 4, wherein an i-th interval of the 2^{B}−1 equally-spaced intervals in [0, A_{D}] is given by [(δᵢ, δᵢ₊₁] for i=0, 1, . . . , M−2, where
$${δ}_{i} = i \times \frac{{A}_{D}}{M - 1}$$
and the ‘out-of-range’ codepoint corresponds to [A_{D}, ∞).

6. The UE of claim 4, wherein a value of M∈ [symbol] is configured via a radio resource control (RRC) parameter, where [symbol] is a set including 32, 64, 128, and 256.

7. The UE of claim 4, wherein a value of A_{D}∈ [symbol] is configured via a radio resource control (RRC) parameter, where [symbol] is a set including 0.5 CP length and 1 CP length.

8. The UE of claim 4, wherein a payload of the second indicator is given by (N_{TRP}−1)B bits and a payload of the third indicator is given by (N_{TRP}−1) bits.

9. A base station (BS) comprising:
a processor; and
a transceiver operably coupled to the processor, the transceiver configured to:
transmit information about a report, wherein the information indicates N_{TRP} antenna groups including a reference antenna group n_{ref}, where N_{TRP}>1, and wherein, for each antenna group n≠n_{ref}, a first delay value Dₙ and a second delay value dₙ, is based on the information and the reference antenna group n_{ref}; and
receive the report including:
a first indicator indicating the reference antenna group n_{ref};
a second indicator indicating, for each antenna group n≠n_{ref}, an interval to which the first delay value Dₙ belongs; and
a third indicator indicating, for each antenna group n≠n_{ref}, whether the second delay value dₙ is inside or outside a pre-defined range via a 1-bit indicator.

10. The BS of claim 9, wherein each antenna group of the N_{TRP} antenna groups corresponds to a respective CSI reference signal (CSI-RS) resource set or a respective CSI-RS resource.

11. The BS of claim 9, wherein the pre-defined range corresponds to [0, 1CP], where the 1CP corresponds to a 1 cyclic prefix (CP) length.

12. The BS of claim 9, wherein:
the interval is indicated by an indicator of size B bits with an alphabet set, where:
the alphabet set includes M=2^{B} codepoints; and
the 2^{B} codepoints correspond to 2^{B}−1 equally-spaced intervals in [0, A_{D}] and an ‘out-of-range’ codepoint, where A_{D}>0.

13. The BS of claim 12, wherein an i-th interval of the 2^{B}−1 equally-spaced intervals in [0, A_{D}] is given by [δᵢ, δᵢ₊₁] for i=0, 1, . . . , M−2, where
$${δ}_{i} = i \times \frac{{A}_{D}}{M - 1}$$
and the ‘out-of-range’ codepoint corresponds to [A_{D}, ∞).

14. The BS of claim 12, wherein a value of M∈ [symbol] is configured via a radio resource control (RRC) parameter, where [symbol] is a set including 32, 64, 128, and 256.

15. The BS of claim 12, wherein a value of A_{D}∈ [symbol] is configured via a radio resource control (RRC) parameter, where [symbol] is a set including 0.5 CP length and 1 CP length.

16. The BS of claim 12, wherein a payload of the second indicator is given by (N_{TRP}−1)B bits and a payload of the third indicator is given by (N_{TRP}−1) bits.

17. A method performed by a user equipment (UE), the method comprising:
receiving information about a report, the information indicating N_{TRP} antenna groups, where N_{TRP}>1;
determining, based on the information, a reference antenna group n_{ref};
determining, based on the information and the reference antenna group n_{ref}, for each antenna group n≠nef, a first delay value Dₙ and a second delay value dₙ; and
transmitting the report including:
a first indicator indicating the reference antenna group n_{ref};
a second indicator indicating, for each antenna group n≠n_{ref}, an interval to which the first delay value Dₙ belongs; and
a third indicator indicating, for each antenna group n≠n_{ref}, whether the second delay value dₙ is inside or outside a pre-defined range via a 1-bit indicator.

18. The method of claim 17, wherein each antenna group of the N_{TRP} antenna groups corresponds to a respective CSI reference signal (CSI-RS) resource set or a respective CSI-RS resource.

19. The method of claim 17, wherein the pre-defined range corresponds to [0, 1CP], where the 1CP corresponds to a 1 cyclic prefix (CP) length.

20. The method of claim 17, wherein:
the interval is indicated by an indicator of size B bits with an alphabet set, where:
the alphabet set includes M=2^{B} codepoints; and
the 2^{B} codepoints correspond to 2^{B}−1 equally-spaced intervals in [0, A_{D}] and an ‘out-of-range’ codepoint, where A_{D}>0.
